(19) United States
(12) Patent Application Publication
(10) Pub. No.: US 2020/0159743 A1
(43) Pub. Date: May 21, 2020

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Satoshi Ito, Kawasaki Kanagawa (JP); Tatsuo Kozakaya, Kawasaki Kanagawa (JP); Yuta Shirakawa, Kawasaki Kanagawa (JP); Susumu Kubota, Meguro Tokyo (JP)

(21) Appl. No.: 16/548,113

(22) Filed: Aug. 22, 2019

(30) Foreign Application Priority Data
Nov. 20, 2018 (JP) 2018-217030

(51) Int. Cl. G06F 16/25; G06F 16/23

(52) U.S. Cl. CPC G06F 16/258; G06F 16/2379

(57) ABSTRACT

An information processing device according to one embodiment includes a first receiver, a second receiver, a first converter, a second converter, and a calculator. The first receiver receives input of first data belonging to a first modality. The second receiver receives input of second data belonging to a second modality that is different from the first modality. The first converter converts the first data into a first representation representing a point or a first area in a D-dimensional vector space (D is a natural number). The second converter converts the second data into a second representation representing a second area in the D-dimensional vector space. The calculator calculates similarity between the first data and the second data by using the first representation and the second representation.

### CROSS-REFERENCE TO RELATED APPLICATIONS

This application is based upon and claims the benefit of priority from Japanese Patent Application No. 2018-217030, filed on Nov. 20, 2018; the entire contents of which are incorporated herein by reference.

### FIELD

Embodiments described herein relate generally to an information processing device, an information processing method, and a computer program product.

### BACKGROUND

In cross-modal retrieval, which has conventionally been known, in response to input of data in a certain modality, data in a different modality is retrieved. For example, an image is retrieved with the input of text or text is retrieved with the input of an image. For highly accurate cross-modal retrieval, it is important to properly calculate by some means the similarity between pieces of data that belong to different modalities.

In the conventional technique, however, the similarity has been calculated with the data of each modality embedded in one point in a common space. Therefore, in the conventional technique, the similarity cannot be calculated for the pieces of data belonging to the different modalities in consideration of the ambiguity of the data having more than one possible meaning (for example, see Japanese Patent Application Laid-open No. 2016-134175 and a non-patent literature “Learning Two-Branch Neural Networks for image-Text matching, PAMI, 2018 (DOI: 10.1109/TPAMI. 2018.2797921)” by L. Wang, Y. Li, J. Huang and S. Lazebnik).

An information processing device according to one embodiment includes a first receiver, a second receiver, a first converter, a second converter, and a calculator. The first receiver receives input of first data belonging to a first modality. The second receiver receives input of second data belonging to a second modality that is different from the first modality. The first converter converts the first data into a first representation representing a point or a first area in a D-dimensional vector space (D is a natural number). The second converter converts the second data into a second representation representing a second area in the D-dimensional vector space. The calculator calculates similarity between the first data and the second data by using the first representation and the second representation.

### BRIEF DESCRIPTION OF THE DRAWINGS

FIG. 1 is a diagram illustrating an example of a functional structure of an information processing device according to one embodiment;

FIG. 2 is a diagram illustrating an example of a conventional similarity calculating method;

FIG. 3 is a diagram illustrating an example of a similarity calculating method according to the embodiment;

FIG. 4A is a diagram illustrating an example of a distance d₁ between areas according to the embodiment;

FIG. 4B is a diagram illustrating an example of the distance d₁ between a point and the area according to the embodiment;

FIG. 5 is a diagram illustrating an example of a distance d₂ between a point and the area according to the embodiment;

FIG. 6 is a flowchart illustrating an example of an information processing method according to the embodiment; and

FIG. 7 is a diagram illustrating an example of a hardware structure of the information processing device according to the embodiment.

### DETAILED DESCRIPTION

An embodiment of an information processing device, an information processing method, and a computer program is hereinafter described in detail with reference to the attached drawings.

### An Example of Functional Structure

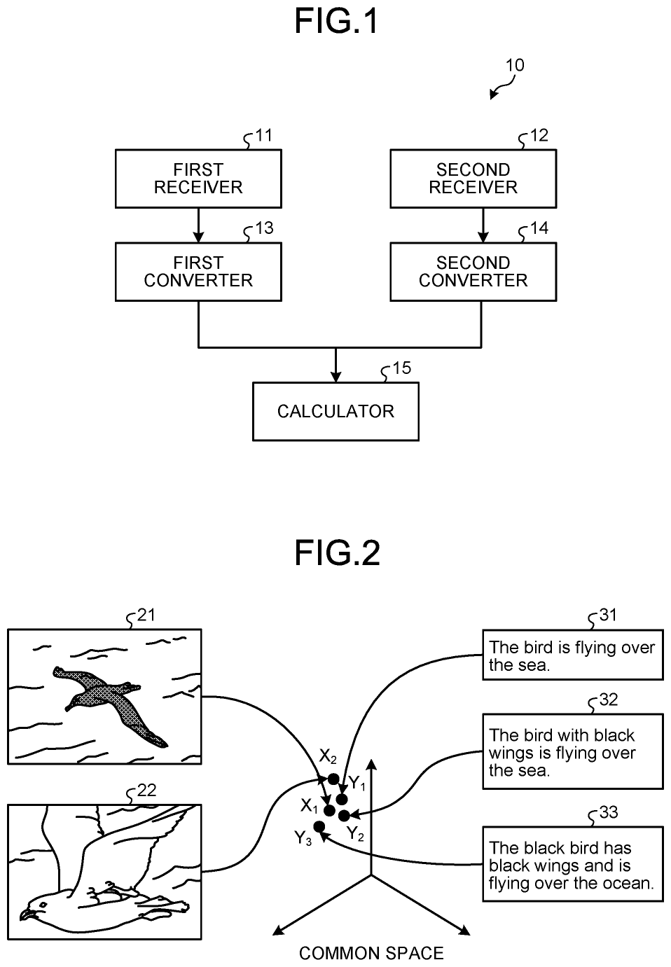

FIG. 1 is a diagram illustrating an example of a functional structure of an information processing device 10 according to one embodiment. The information processing device 10 according to the embodiment includes a first receiver 11, a second receiver 12, a first converter 13, second converter 14, and a calculator 15.

The first receiver 11 receives the input of first data that belongs to a first modality. Here, modality refers to a certain kind of information (or format to express that information). Specific examples of the modality include visual information, audio information, environmental sound information, linguistic information (text), motion information, biological information, and sensor information. The visual information is, for example, a still image and a moving image. The motion information is, for example, motion capture data and an optical flow of an image. The biological information is, for example, a pulse. The sensor information is, for example, tactile information, smell information, and information expressing a state of a machine.

The first modality indicates any one of the aforementioned modalities. The format of the first data, which may vary depending on the kind of the first modality, is basically tensor data. In one example, a still image in grayscale can be expressed in two-dimensional tensor data. In another example, a moving image in grayscale can be expressed in three-dimensional tensor data. In still another example, audio information and environmental sound information can be expressed in one-dimensional tensor data.

Other modalities can similarly be expressed in tensor data. A method of expressing the modality in tensor data is described supplementarily by using linguistic information (text) as a specific example. The text data is, for example, “a bird is flying over the sea.” Needless to say, since “a bird is flying over the sea” is not the tensor data, this text needs to be converted into the tensor data. This conversion can employ, for example, Word2Vec model and Sentence2Vec (or Doc2Vec model), which are generally well known.

Word2Vec model is a model to convert a word into vector representation. Sentence2Vec is a model to convert a sentence into vector representation.

The first receiver 11 may receive the input of the first data as the tensor data. If the first data is text data or the like, the first receiver 11 may convert the first data into the tensor data.

The second receiver 12 receives the input of second data belonging to a second modality that is different from the first modality. For example, if the first modality is the still image, the second modality is other modality than the still image (for example, text data).

The first converter 13 converts the first data into a first representation X representing a point or a first area in a D-dimensional vector space (D is a natural number). The D-dimensional vector space is, for example, an Euclidean space. In the description of the embodiment, the D-dimensional vector space is the Euclidean space.

If the first representation X represents the point, the first representation X is expressed by the following Expression (1).

X=(x₁,x₂, . . . ,x₀)^{T}∈R^{D} (1)

In the expression, T represents the transposition of the vector, and R^{D} represents the D-dimensional Euclidean space.

Next, the case where the first representation X represents the area is described. In the embodiment, if the first representation X represents the area, the area is represented as the area in the D-dimensional Euclidean space.

In the representation by the area, differently from the representation by the point, various models that can be represented parametrically can be used. The representation by the area is, for example, a hyperplane, a polytope, a hypersphere, or a complementary set thereof. In another example, the representation by the area may be a K-dimensional subspace formed by K number of bases (K is a natural number smaller than D). In still another example, the representation by the area may be the area sectioned by a hyperplane, and this is expressed by the following Expression (2).

x(θ,b)={x|x∈R^{D}∧θ^{T}x−b≥0} where θ∈R^{D}, b∈R (2)

In the expression (2), θ and b are parameters that define the hyperplane. The representation by the area may be expressed by a plurality of the aforementioned representations by the areas that are prepared and combined as a sum set or a product set. The areas to be combined may be either the models of the same kind or the different kinds. Specifically, for example, a product set of three hyperplanes or a sum set of a polytope and a hypersphere may be employed.

To convert the first data into the first representation X, an encoder model, which is one kind of a neural network model, may be used For example, in the case of using the area representation of Expression (2) above, an encoder model that outputs the total (D+1) parameters of (θ^{T}, b)^{T} may be used. In the case of using the K-dimensional subspace as the area representation, an encoder model that outputs K×D parameters may be used.

On the other hand, the second converter 14 converts the second data into a second representation Y representing a second area in the D-dimensional vector space. In the description of the embodiment, the D-dimensional vector space is the D-dimensional Euclidean space. The second area is not described here because the second area is similar to the first area.

Here, the advantage of the representation by the area is described using an example.

FIG. 2 is a diagram illustrating an example of a conventional similarity calculating method. In the example in FIG. 2, the similarity is calculated by embedding the data of each modality in one point in a common space. In the example in FIG. 2, the first modality is still images 21 and 22, and the second modality is texts 31 to 33.

The still image 21 corresponds to a first representation X₁. The still image 22 corresponds to a first representation X₂. The text 31 corresponds to a second representation Y₁. The text 32 corresponds to a second representation Y₂. The text 33 corresponds to a second representation Y₃. In the example in FIG. 2, the first representations X₁ and X₂ and the second representations Y₁ to Y₃ are the points in the common space that is expressed by the three-dimensional Euclidean space.

While a bird in the still image 21 has black wings, bird in the still image 22 does not have black wings. Therefore, the text 31 applies to both the still images 21 and 22. On the other hand, the texts 32 and 33 apply to the still image 21 but not to the still image 22. To increase the similarity of the corresponding pair and decrease the similarity of the non-corresponding pair are difficult in the conventional representation by the point. Specifically, in the example in FIG. 2, in the case where the similarity is determined in accordance with the distance between the points, for example, it is difficult to increase the similarity of the corresponding pair and decrease the similarity of the non-corresponding pair.

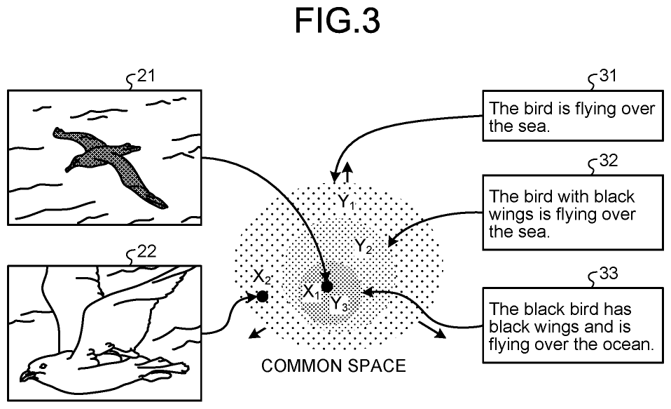

FIG. 3 is a diagram illustrating an example of a similarity calculating method according to the embodiment. In the example in FIG. 3, the second converter 14 converts the texts 31 to 33 not into the representation by the points but into the representation by the areas.

The still image 21 corresponds to the first representation X₁. The still image 22 corresponds to the first representation X₂. The text 31 corresponds to the second representation Y₁. The text 32 corresponds to the second representation Y₂. The text 33 corresponds to the second representation Y₃. In the example in FIG. 3, the first representations X₁ and X₂ are the points in the common space that is expressed by the three-dimensional Euclidean space. On the other hand, the second representations Y₁ to Y₃ are the areas in the common space that is expressed by the three-dimensional Euclidean space.

In the case where the second representations Y₁ to Y₃ are represented by the area, it can be confirmed that the relation described above in FIG. 2 is satisfied. That is to say, the second representation Y₁ representing the text 31 includes the first representations X₁ and X₂ represented by the points, and thus applies to both the still images 21 and 22. On the other hand, the second representation Y₂ representing the text 32 includes the first representation X₁ represented by the point, and thus applies to the still image 21 but not to the still image 22 because the second representation Y₂ does not include the first representation X₂ represented by the point. The second representation Y₃ representing the text 33 is similar to the second representation Y₂ representing the text 32.

The point representation and the area representation that satisfy the properties as illustrated in the example in FIG. 3 are obtained by optimizing the encoder model as described above through machine learning. That is to say, for the pair of the first data and the second data for which the high similarity is desired, the parameter of the encoder model is optimized so that the similarity will be increased. At the same time, for the pair for which the low similarity is desired, the optimization may be performed so that the similarity will be decreased. For the optimization, a stochastic gradient method or the like can be used.

Back to FIG. 1, the calculator 15 calculates similarity s between the first data and the second data using the first representation X and the second representation Y. The s is a value that does not monotonically increase, for example, as a distance d₁ between the first representation X and the second representation Y increases. The value s that monotonically does not increase with respect to the distance d₁ is most simply expressed as s=−d₁and there are many other expressions. Note that the monotonically does not increase means that if d₁<d₁′, then s(d₁)≥s(d₁′). Here, s(d₁) represents the similarity defined based on d₁ and s(d₁′) represents the similarity defined based on d₁′.

If the first representation X and the second representation Y are represented by the areas, the distance d₁ is expressed by the following Expression (3).

$${d}_{1} = {min}_{x ∈ X , y ∈ Y} {\vert x - y \vert}_{2} \qquad ( 3 )$$

In this expression (3), |x|₂ represents L2 norm of x.

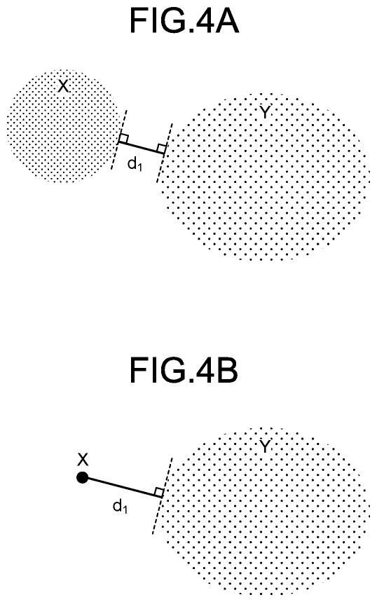

FIG. 4A is a diagram illustrating an example of the distance d₁ between the areas in the embodiment. In the example in FIG. 4A, the distance d₁ is expressed by the above Expression (3).

In the case where the first representation X is represented by the point and the second representation Y is represented by the area, when the vector representing the point is X, the above Expression (3) is simplified into the following Expression (4).

$${d}_{1} = {min}_{y ∈ Y} {\vert x - y \vert}_{2} \qquad ( 4 )$$

FIG. 4B is a diagram illustrating an example of the distance d₁ between the point and the area in the embodiment. In the example in FIG. 4B, the distance d₁ is expressed by the above Expression (4).

As is understood from the above Expressions (3) and (4), the distance d₁ is zero if the first representation X is included in the second representation Y. Therefore, the distance is more likely to be zero as compared to the conventional case (see FIG. 2). In the case where the cross-modal retrieval is performed using the similarity based on the distance d₁ in FIG. 4A and FIG. 4B, if there are a plurality of samples with a distance of zero (that is, the highest similarity is taken), then the retrieval results cannot be ranked. If any one of the samples with a distance of zero may be used as the result, this will not result in a problem. However, if the retrieval results need to be ranked, some solution has to be done. For this solution, there are cases where the first representation X is represented by the point representation and by the area representation.

A case where the first representation X is represented by point representation

First, if the first representation X is a point, a distance d₂ to the point from an outside of the area (a point outside the area) corresponding to the second representation Y is defined by the following Expression (5).

$${d}_{2} = {min}_{y ∈ V - Y} {\vert x - y \vert}_{2} \qquad ( 5 )$$

In the expression (5), V represents the entire D-dimensional Euclidean space.

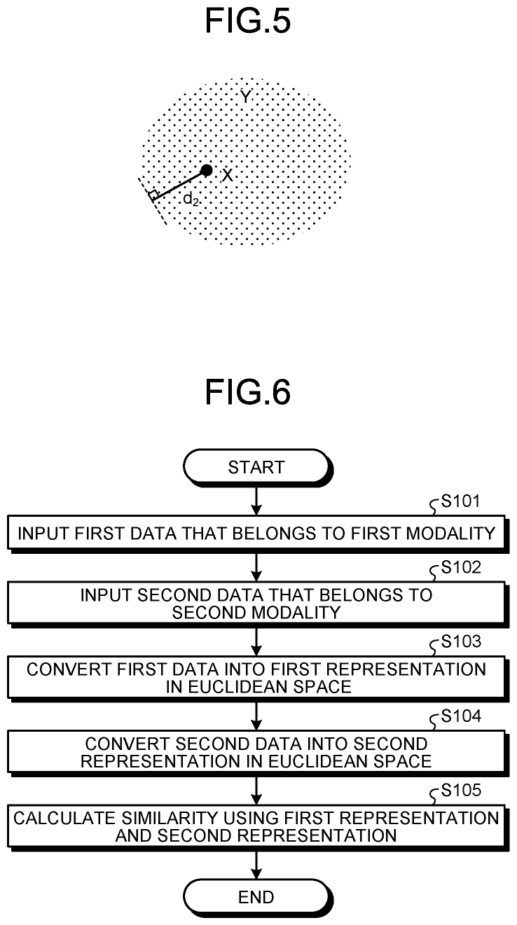

FIG. 5 is a diagram illustrating an. example of the distance d₂ between the point and the area in the embodiment. In the example in FIG. 5, the distance d₂ is expressed by the above Expression (5).

It should be noted that one of the distances d₁ and d₂ is zero as is clear from the above Expressions (1) and (5). In addition, a distance d₃ is determined by the following Expression (6).

d₃=d₁−d₂ (6)

The distance d₃ can be a value other than zero depending on the distance d₂ even in the case where the distance d₁ is zero. Therefore, by using, as the similarity s, the value that monotonically does not increase as the distance d₃ increases, the problem of the ranking of the retrieval results can be solved. Note that the similarity s in this case monotonically does not increase as the distance d₁ between the first representation X and the second representation Y increases and monotonically non-decreases as the distance d₂ from an outside of the area corresponding to the second representation Y to the point corresponding to the first representation X increases.

A case where the first representation X is represented by area representation.

Next, the case in which the first representation X is represented by the area representation is described. In this case, an overlapping degree r between the first representation X (first area X) and the second representation Y (second area Y) is considered. For example, the following Expression (7) can be used for the overlapping degree r.

r=|X [symbol] Y|/|X [symbol] Y| (7)

In the expression (7), |A| represents the volume of a set A.

In another example, the following Expression (8) without the denominator of Expression (7) may be used for the overlapping degree r.

r=|X [symbol] Y| (8)

In still another example, the following Expression (9) that maximizes x in the above Expression (5) may be used for the overlapping degree r.

$$r = {max}_{x ∈ X} {min}_{y ∈ V - Y} {\vert x - y \vert}_{2} \qquad ( 9 )$$

If the first representation X is represented by the area representation, a distance d₄ is determined by the following Expression (10) in a manner similar to the above Expression (6).

d₄=d₁−r (10)

The distance d₄ can be a value other than zero depending on the overlapping degree r even in the case where the distance d₁ is zero. Therefore, by using, as the similarity s, a value that monotonically does not increase as the distance d₄ increases, the aforementioned problem of the ranking of the retrieval results can be solved. Note that the similarity in in this case monotonically does not increase as the distance d₁ between the first representation X and the second representation Y increases and monotonically non-decreases as the overlapping degree r between the first representation X (first area X) and the second representation Y (second area Y) increases.

### Example of Information Processing Method

FIG. 6 is a flowchart illustrating an example of an information processing method according to the embodiment. First, the first receiver 11 receives the input of the first data belonging to the first modality (step S101). Next, the second receiver 12 receives the input of the second data belonging to the second modality that is different from the first modality (step S102).

Next, the first converter 13 converts the first data into the first representation X (step S103). Subsequently, the second converter 14 converts the second data into the second representation Y (step S104).

Next, the calculator 15 calculates the similarity between the first data and the second data by using the first representation X and the second representation Y (step S105).

As described above, in the information processing device 10 according to the embodiment, the first receiver 11 receives the input of the first data belonging to the first modality. The second receiver 12 receives the input of the second data belonging to the second modality that is different from the first modality. The first converter 13 converts the first data into the first representation X representing the point or the first area in the D-dimensional vector space (D is a natural number). The second converter 14 converts the second data into the second representation Y representing the second area in the D-dimensional vector space. Then, the calculator 15 calculates the similarity s between the first data and the second data by using the first representation X and the second representation Y.

Thus, the information processing device 10 according to the embodiment can calculate the similarity of the data belonging to the different modalities in consideration of the ambiguity of the data. Specifically, at least one of the data belonging to the two different modalities is converted into the area representation and, embedded in the common space (D-dimensional vector space); thus, even in the case where the data has ambiguity, the similarity can be calculated as appropriate.

Finally, an example of a hardware structure of the information processing device 10 according to the embodiment is described.

### Example of Hardware Structure

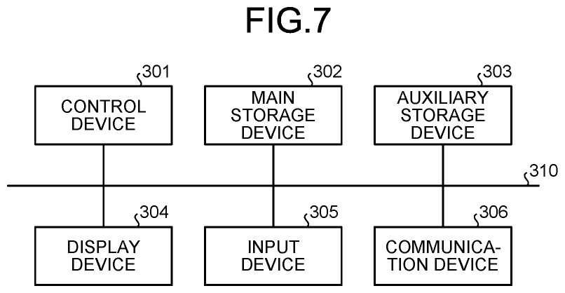

FIG. 7 is a diagram illustrating the example of the hardware structure of the information processing device 10 according to the embodiment.

The information processing device 10 according the embodiment includes a control device 301, a main storage device 302, an auxiliary storage device 303, a display device 304, an input device 305, and a communication device 306. The control device 301, the main storage device 302, the auxiliary storage device 303, the display device 304, the input device 305, and the communication device 306 are connected to each other through a bus 310.

The control device 301 executes a computer program read out from the auxiliary storage device 303 to the main storage device 302. The main storage device 302 is a memory such as a read only memory (ROM) or a random access memory (RAM). The auxiliary storage device 303 is a hard disk drive (HDD), a memory card, or the like.

The display device 304 displays display information. The display device 304 is, for example, a liquid crystal display. The input device 305 is an interface used to operate the information processing device 10. The input device 305 is, for example, a keyboard or a mouse. If the information processing device 10 is a smart device such as a smartphone or a tablet terminal, the display device 304 and the input device 305 is a touch panel, for example. The communication device 306 is an interface used to communicate with another device.

The computer program to be executed in the information processing device 10 according to the embodiment is recorded in a computer-readable storage medium such as a CD-ROM, a memory card, a CD-R, or a digital versatile disc (DVD) as a file in an installable or executable format, and provided as a computer program product.

The computer program to be executed in the information processing device 10 according to the embodiment may alternatively be provided in a manner that the computer program is stored in a computer connected to a network such as the Internet and downloaded through the network. The computer program to be executed in the information processing device 10 according to the embodiment may be provided through the network such as the Internet without being downloaded.

The computer program to be executed in the information processing device 10 according to the embodiment may be provided by being incorporated in a ROM or the like in advance.

The computer program to be executed in the information processing device 10 according to the embodiment has a module structure including, out of the aforementioned function blocks, a function block that can be implemented by a computer program. The function blocks are loaded in the main storage device 302 when, as the actual hardware, the control device 301 reads out the computer program from the storage medium and executes the computer program. That is to say, the function blocks are generated in the main storage device 302.

The function blocks described above may entirely or partially be implemented by hardware such as an integrated circuit (IC) instead of by software.

If the functions are implemented by a plurality of processors, each processor may implement one function, or two or more functions out of those functions.

The information processing device 10 according to the embodiment may operate in any desired mode. The information processing device 10 according to the embodiment may operate in a cloud system on the network, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a first receiver that receives input of first data belonging to a first modality;
a second receiver that receives input of second data belonging to a second modality that is different from the first modality;
a first converter that converts the first data into a first representation representing a point or a first area in a D-dimensional vector space, D being a natural number;
a second converter that converts the second data into a second representation representing a second area in the D-dimensional vector space; and
a calculator that calculates similarity between the first data and the second data by using the first representation and the second representation.

2. The information processing device according to claim 1, wherein each of the first area and the second area is at least one of areas sectioned by one or more hyperplanes in the D-dimensional vector space and a K-dimensional subspace in the D-dimensional vector space, K being a natural number that is smaller than D.

3. The information processing device according to claim 1, wherein the similarity is a value that does not monotonically increase as a distance between the first representation and the second representation increases.

4. The information processing device according to claim 1, wherein when the first representation is a point, the similarity is a value that does not monotonically decrease as a distance between the point and an outside of the second area increases.

5. The information processing device according to claim 1, wherein when the first representation is the first area, the similarity is a value that does not monotonically decrease as an overlapping degree between the first area and the second area increases.

6. The information processing device according to claim 1, wherein the D-dimensional vector space is an Euclidean space.

7. The information processing device according to claim 1, wherein each of the first modality and the second modality is visual information, audio information, environmental sound information, linguistic information, motion information, biological information, or sensor information.

8. An information processing method comprising:
receiving input of first data belonging to a first modality;
receiving input of second data belonging to a second modality that is different from the first modality;
converting the first data into a first representation representing a point or a first area in a D-dimensional vector space, D being a natural number;
converting the second data into a second representation representing a second area in the D-dimensional vector space; and
calculating similarity between the first data and the second data by using the first representation and the second representation.

9. The information processing method according to claim 8, wherein each of the first area and the second area is at least one of areas sectioned by one or more hyperplanes in the D-dimensional vector space and a K-dimensional subspace in the D-dimensional vector space, K being a natural number that is smaller than D.

10. The information processing method according to claim 8, wherein the similarity is a value that does not monotonically increase as a distance between the first representation and the second representation increases.

11. The information processing method according to claim 8, wherein when the first representation is the point, the similarity is a value that does not monotonically decrease as a distance between the point and an outside of the second area increases.

12. The information processing method according to claim 8, wherein when the first representation is the first area, the similarity is a value that does not monotonically decrease as an overlapping degree between the first area and the second area increases.

13. The information processing method according to a claim 8, wherein the D-dimensional vector space is an Euclidean space.

14. The information processing method according to claim 8, wherein each of the first modality and the second modality is visual information, audio information, environmental sound information, linguistic information, motion information, biological information, or sensor information.

15. A computer program product having a non-transitory computer readable medium comprising instructions, wherein the instructions, when executed by a computer, cause the computer to perform:
receiving input of first data belonging to a first modality;
receiving input of second data belonging to a second modality that is different from the first modality;
converting the first data into a first representation. representing a point or a first area in a D-dimensional vector space, D being a natural number;
converting the second data into a second representation representing a second area in the D-dimensional vector space; and
calculating similarity between the first data and the second data by using the first representation and the second representation.
